(19) United States
(12) Patent Application Publication
(10) Pub. No.: US 2013/0208938 A1
(43) Pub. Date: Aug. 15, 2013

(54) SYSTEMS OF APPAREL WITH INBUILT DEVICES FOR COMMUNICATION, ENTERTAINMENT, LEARNING AND HEALTH MONITORING

(71) Applicant: Vivek Midha, New Delhi (IN)

(72) Inventor: Vivek Midha, New Delhi (IN)

(21) Appl. No.: 13/880,051

(22) PCT Filed: Oct. 21, 2010
(86) PCT No.: PCT/IB11/54722

§ 371 Date: Apr. 18, 2013

(30) Foreign Application Priority Data
Oct. 21, 2010 (IN) 2504/DEL/2011

(51) Int. Cl. H04R 1/44

(52) U.S. Cl. CPC H04R 1/44
USPC 381/333; 340/870.02

(57) ABSTRACT

Disclosed is a system of an apparel to operate atleast a functional device without holding in an user's hands. The system comprises atleast a communicator inbuilt with the apparel and communicably connected with the functional device, atleast a controller inbuilt with the apparel to control operation of the functional device, and atleast a connector inbuilt with the apparel to detachably connect atleast one of the functional device, the communicator, the controller or any combination thereof. Atleast one of the communicator, connector, the controller, the functional device or any combination thereof is substantially water resistant and washable with the apparel.

### FIELD OF THE INVENTION

The present invention relates generally to clothing with inbuilt devices, and more particularly to systems of apparel with atleast an inbuilt washable device for communication, entertainment, learning, and health monitoring without holding the devices in user's hands in a more practical, more efficient, cost effective and environment friendly manner.

### BACKGROUND OF THE INVENTION

Advancement of technologies is contributing in making peoples life simple, convenient, cost effective, and fast. The fastness of life has also necessitated need to have on-demand availability of technology for entertainment, communication, learning and health monitoring.

Numerous types of gadgets are available in the commercial market for communication, entertainment, learning and health monitoring. Efforts have been made to incorporate/inbuilt electronic gadgets in the clothing for convenience of use.

The prior art discloses numerous techniques for incorporating electronic gadgets in the clothing. For example, U.S. Publication No. 20090161899 discloses garment with a speaker function. The garment includes a garment body, a bag, and an electret speaker. The bag disposed on the garment body includes a sound-absorbing layer. The electret speaker, disposed in the bag, gives off sounds to a first direction and a second direction at the same time.

U.S. Pub. No. 20090123000 discloses wearable personal sound delivery apparatus which can be worn by a person has speakers held close to the ears and does not include any insert into the auditory canal or any ear muff that could muffle or suppress other ambient sounds.

Although, the prior art discloses numerous techniques for incorporating electronic gadgets in the clothing, such as jackets, which incorporate variety of electronic devices. However, the quality, functionality, and security of such items is restricted due to the requirement of washability of clothing as it is often the case that such items cannot be laundered in a conventional manner without causing damage to the electronic components. Further, no prior art discloses system and methods of clothing/apparel with inbuilt washable electronic gadgets for communication, entertainment, learning and health monitoring.

In view of the disadvantages inherent in the conventional clothing items incorporating electronic gadgets, it has remained a constant concern to provide apparel or clothing with inbuilt washable means for communication, entertainment, learning and health monitoring in a secure, more practical, more efficient, cost effective and environment friendly manner.

### SUMMARY FOR THE INVENTION

In view of the disadvantages inherent in the conventional clothing items incorporating electronic gadgets, the general purpose of the present invention is to provide systems and methods of apparel or clothing with atleast one of inbuilt washable communication, entertainment, learning, health monitoring means and other electronic gadgets in a more practical, more efficient, cost effective and environment friendly manner, to include advantages of the prior art, and to overcome the drawbacks inherent therein.

In one aspect, the present invention provides a system of an apparel to operate atleast a functional device without holding in a user's hands. The system comprises atleast a communicator inbuilt with the apparel and communicably connected with the functional device, atleast a controller inbuilt with the apparel to control operation of the functional device, and atleast a connector inbuilt with the apparel to detachably connect atleast one of the functional device, the communicator, the controller or any combination thereof. Atleast one of the communicator, connector, the controller, the functional device or any combination thereof is substantially water resistant. The system is capable of facilitating communication, health monitoring, learning, entertainment, and enjoyment.

In another aspect, the present invention provides an apparel with atleast an inbuilt washable device for communication, entertainment, enjoyment, and health monitoring. The apparel comprises atleast a washable speaker inbuilt at a suitable position in the apparel, atleast a washable earphone communicably connected with atleast one of a washable microphone and the washable speaker, atleast a washable controller inbuilt with the apparel for receiving input from the user to control and operate the washable device through the apparel, atleast a monitor connected with the apparel to communicably monitor atleast health of the user. Atleast an inbuilt washable connector is adapted to connect atleast one of the washable device, the washable speaker, the washable headphone, the washable microphone or any combination thereof with the washable operator for operation of the washable device by the user wearing the apparel.

These together with other aspects of the present invention, along with the various features of novelty that characterize the invention, are pointed out with particularity in the detailed description forming a part of this disclosure. For a better understanding of the present invention, its operating advantages, and the specific objects attained by its uses, reference should be made to the accompanying drawings and descriptive matter in which, there are illustrated exemplary embodiments of the present invention.

### BRIEF DESCRIPTION OF THE DRAWINGS

While the specification concludes with claims that particularly point out and distinctly claim the present invention, it is believed the expressly disclosed exemplary embodiments of the present invention can be well understood from the following detailed description taken in conjunction with the accompanying drawings, in which like reference numerals identify the same elements. The drawings and detailed description which follow are intended to be merely illustrative of the expressly disclosed exemplary embodiments and are not intended to limit the scope of the invention as set forth in the appended claims. In the drawings:

FIG. 1 illustrates a system of an apparel to operate atleast a functional device without holding in a user's hands, according to an exemplary embodiment of the present invention;

FIG. 2 illustrates an apparel for communication, entertainment, enjoyment, learning and health monitoring without holding in a user's hands, according to an exemplary embodiment of the present invention; and

FIGS. 3A-3C illustrates the exemplary systems of apparel with inbuilt devices, according to another exemplary embodiment of the present invention.

Like reference numerals refer to like parts throughout several views of the drawings of the present invention.

### DESCRIPTION OF THE INVENTION

The exemplary embodiments of the present invention, described herein detail for illustrative purposes, are subject to many variations, structure and design. It should be emphasized, however that the present invention is not limited to particular system or methods for communication and health monitoring, as shown and described. On the contrary, a person skilled in the art will appreciate that many other embodiments of the present invention are possible without deviating from the basic concept of the present invention as the principles of the present invention can be used with a variety of communication and health monitoring methods and structural arrangements. It is understood that various omissions, substitutions of equivalents are contemplated as circumstances may suggest or render expedient, but the present invention is intended to cover such alternatives, modifications, and equivalents as can be reasonably included within the scope of the present invention and any such work around will also fall under scope of the present invention without departing from the spirit or scope of the its claims.

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘atlease’ do not denote a limitation of quantity, but rather denote the presence of at least one of the referenced item. The term ‘clothing’, ‘apparel’, ‘garment’ may also be used herein interchangeably. The term ‘system’ also includes ‘machine’, ‘device’, and ‘apparatus’.

The terms ‘audio device’, ‘video device’, ‘audio player, ‘video player, ‘media system’ and ‘media device’ denotes same thing and may be used herein interchangeably. The media device may be of any device capable of communicating media content. The media content may include atleast one of an audio, a video or both audio and video. The term ‘communicating’ also includes displaying. The functional device includes atleast one of electronic device and non-electronic device.

According to an exemplary embodiment, the present invention provides effective systems and methods of apparel/clothing with inbuilt washable means or electronic gadgets for communication, entertainment/enjoyment and health monitoring, in a more practical, more efficient, cost effective, secure, and environment friendly manner.

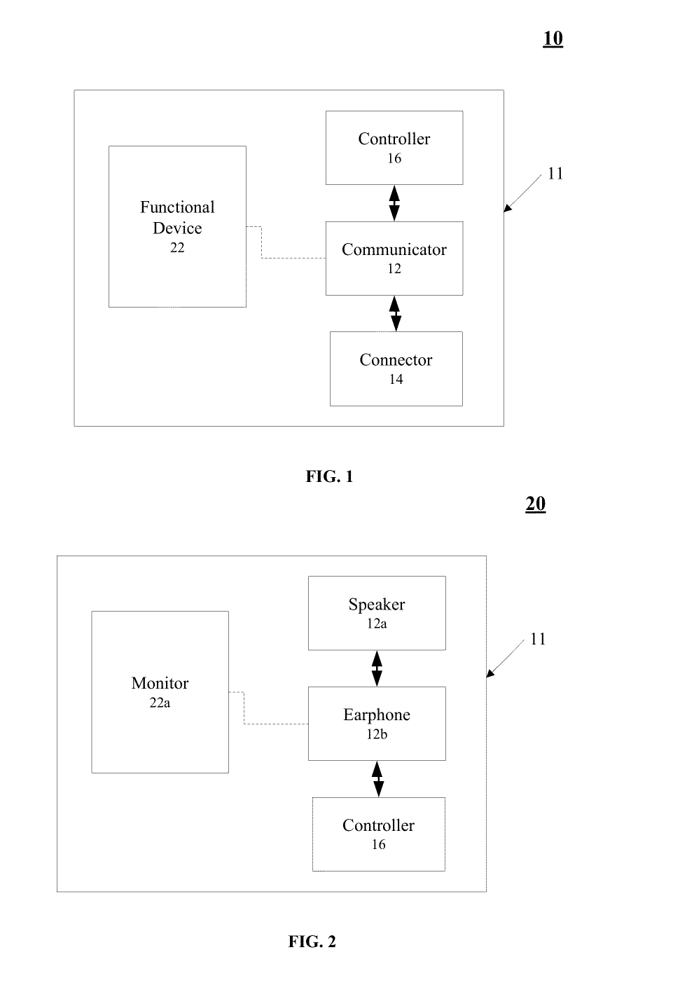

Referring to FIG. 1 which illustrates a system 10 of an apparel 11 to operate atleast a functional device 22 without holding it in a user's hands, according to an exemplary embodiment of the present invention. The system 10 comprises atleast a communicator 12 inbuilt with the apparel 11 and communicably connected with the functional device 22, atleast a controller 16 inbuilt with the apparel 11 to control operation of atleast the functional device 22, and atleast a connector 14 inbuilt with the apparel 11 to detachably connect atleast one of the functional device 22, the communicator 12, the controller 16 or any combination thereof. The system 10 is capable of facilitating communication, health monitoring, learning, entertainment, and enjoyment in a convenient and on-demand manner.

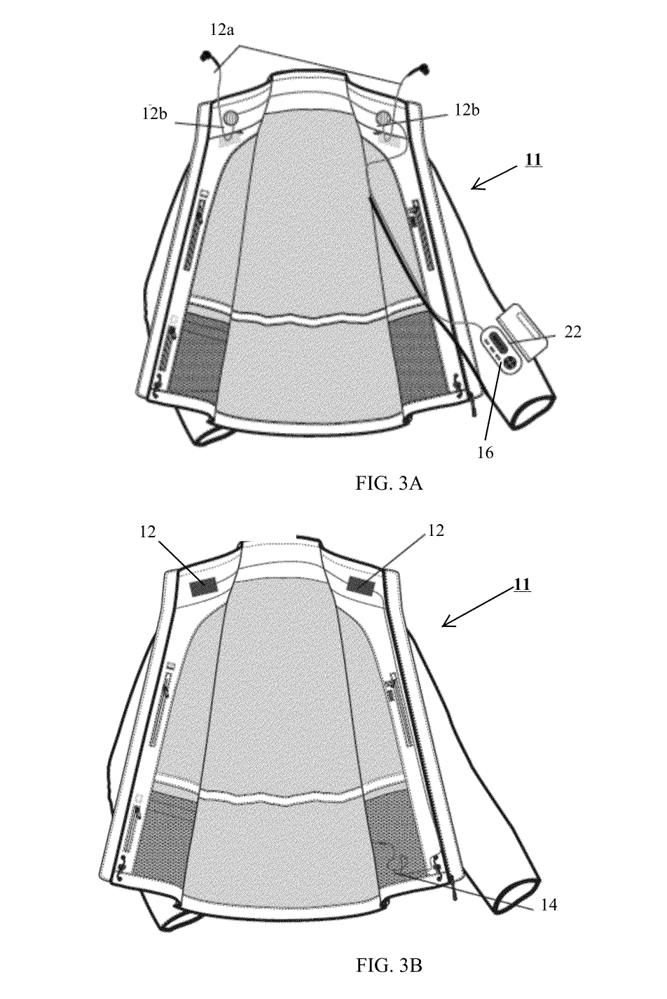

Referring to FIG. 2 which illustrates an apparel 11 comprising atleast an inbuilt washable device for communication, entertainment, enjoyment, and health monitoring. The washable device includes atleast one of a washable speaker 12a (also referred to as ‘mic’) inbuilt at a suitable position in the apparel 11, atleast a washable earphone 12b (also referred to as ‘headphone’) communicably connected with atleast the washable speaker 12b, atleast a washable controller 16 inbuilt with the apparel 11 for receiving input from the user to control and operate the functional device 22 (as shown in FIG. 1) through the apparel 11.

Atleast a monitor 22a is communicably connected with the apparel 11 to monitor atleast health of the user. Atleast an inbuilt washable connector 14 (as shown in FIG. 1) is adapted to connect atleast one of the washable device, the washable speaker 12b, the washable headphone or ear phone 12b, the washable microphone or speaker 12a or any combination thereof with the controller 16 for operation and control of the washable device by the user wearing the apparel 11. The controller 16 inbuilt with the apparel 11 to receive input from the user to control and operate the functional device 22 through the apparel 11.

According to an exemplary embodiment of the present invention, the functional device 22 includes atleast one of a mobile phone, a portable media player, a MP-3 player, a MP-4 player, an i-pad, a CD player, a DVD players, a tablet PC, a PDA, a media player ,a radio, a mobile phone, a RealAudio, a RTM player, a minidisk player, a cassette player, a satellite radio, a GPRS, a blue-tooth, a solar charger, a Wi-Fi, a camera, a personnel assistant, a GSM phone adopter, an universal remote control, a VoIP mode, a monitor, a storage, a digital book, brain trainer, habit builder, work out tracker, project management, temperature controller, language trainer, games playing, text book storage, digital book, audio recording, production efficiency work wear, or any combination thereof.

The functional device 22 may be detachably mounted on the apparel 11. Alternatively, the functional device 22 may also be permanently mounted to the apparel 11 or otherwise provided therein. The apparel 11 may be embedded with recording devise with memory, for example, the personnel assistant, in which user can feed in the daily, weekly & monthly plans and the apparel nor device 22 may automatically keep on prompting on specified time for immediate and timely action for the assigned.

The solar charger is adapted to automatically charge said functional device 22 with solar power once the functional device contact/connect with the apparel 11. The Wi-Fi is adapted the make the system 10 and 20 Wi-Fi enabled. The digital record camera is adapted to record and take pictures and videos. The personnel assistant is adapted for feed in the plans such that the system 10 and 20 may automatically keep on prompting the user on specified time like a personnel assistant for immediate and timely action for the assigned task. The universal remote control is adapted to control all the devices in pockets or around thru the apparel 11.

The GSM phone adopter is adapted to provide the system 10 and 20 full convenience of using all the mobile functions and applications thru the apparel 11. The VoIP mode is capable of providing free and paid VOIP Calling facility such as Skype, jumbo, thru the apparel 11. The VoIP caller is capable of providing details about signal strength and cost of different network operators in order to provide the user an option of select a low cost VoIP GSM operator network having strong signal strength among a plurality of VOIP GSM operators.

According to an exemplary embodiment of the present invention, the monitor 22a includes atleast one of a health tracker capable of tracking, recording and prompting about atleast a health parameter at a predefined time intervals. The health parameters includes atleast one of pulse rate, blood pressure, body temperature, weight, memory, body mass index, Calorie, heart. The health tracker may keep the record of body mass index and suggest the minimum work out required for the body and prompt it time to time. A pre-recorded weight control mode can help controlling, e.g., loosing, weight.

The apparel 11 may be embedded with pre-recorded memory building mode which may help to sharpen human memory rapidly. Start with a baseline evaluation, after learning their first system, users, e.g., students may improve their average score substantially, e.g., by over 300%. A pulse rate monitor may be embedded with a device 22 which will keep the record of pulse rate heart rate monitoring system and monitor heart rate every second, based on the heart rate maximum and minimum put in by hand, store the data and alarm the user for any abnormality or risk.

According to an exemplary embodiment of the present invention, the body temperature monitor may embedded a device which will keep the record of user's body temperature. A special fabric is adapted to make the apparel. The fabric is capable of adjusting the inner temperature according to outside temperature. A memory builder may embedded memory builder programme which will help to sharpen memory. The body mass index may suggest the minimum work out required for the body. A Calorie control meter may keep a record of calorie burned during the specific time. A Heart Rate Monitor may embedded a devise which will keep the record of user's body temperature.

According to an exemplary embodiment of the present invention, a brain trainer is adapted to train human brain for focused thinking. Further, a media, e.g. audio, based habit builder module may be embedded with the apparel 11 to help to build certain habits like quit smoking. The habit builder may have pre-recorded habit building program.

According to an exemplary embodiment of the present invention, a work out tracker may be embedded with the apparel 11 to keep the record of user's workouts or exercise. The recorded workouts may be played back and downloaded on the computer. A project Management (Gantt chart) will embedded a programme which will help to track of the project and help in timely completion.

According to an exemplary embodiment of the present invention, the apparel may adjust temperature according to weather condition and temperature.

According to an exemplary embodiment of the present invention, the system 10 or 20 is capable of providing language learning, games playing, text book storage, and audio-video recording functionalities. The apparel 11 may be embedded with grade wise & subject wise text books of different schools. The apparel may be embedded with a voice recorder in which one can record lectures, speeches and conversation thru inbuilt mike in the apparel 11.

According to an exemplary embodiment of the present invention, the communicator 12 includes atleast one of an inbuilt flexible washable speaker, an inbuilt washable earphone coupled with atleast a washable microphone or a mic. The communicator 12 is capable of facilitating audio and video communication, such as music, commentary, chat, movie, game and the like.

According to an exemplary embodiment of the present invention, the controller 16 includes atleast one of skip, forward, rewind, accept phone calls, reject phone calls, stop media, start media, pause media, call drop, redial, audio play, send multimedia messages, Bluetooth connectivity, Wi-Fi, media recording, play games, operate mobile applications, voice control, power-on, power-off, video play, voice dial, mute, select music, select sound effect, volume control, gesture control buttons, switches or functionalities or any combination thereof are adapted to control the electronic devices. The gesture controls functions are capable of controlling the devices with embedded gesture technology.

According to an exemplary embodiment of the present invention, the connector 14 includes atleast one of a washable media jack, washable connecting wires, and washable connecting switches.

According to an exemplary embodiment of the present invention, the apparel 11 may includes atleast one of a jacket, shirt, T-shirt, trouser, cap, tie, skirt, gloves, socks, sweater, inner garments, wrist band, lower garment, upper garment or any combination thereof. The apparel 11 may comprise many shapes and materials.

According to an exemplary embodiment of the present invention, atleast one of the apparel 11, communicator 12, the flexible speaker 12a, the earphone 12b connector 14, the controller 16, the functional device 22 or any combination thereof is substantially water resistant and may be washed without causing any damage.

According to an exemplary embodiment of the present invention, atleast one of the apparel 11, communicator 12, the flexible speaker 12a, the earphone 12b connector 14, the controller 16, the functional device 22 or any combination thereof may communicate wirelessly. Still other suitable configurations will be apparent to those of ordinary skill in the art.

According to an exemplary embodiment of the present invention, the apparel 11 may have atleast a waterproof retainer with magnetic closures to retain atleast one of the functional device 22, controller 16, communicator 12, the connector 14 and preventing them from falling out of user's pockets. The retainer includes hidden pocket with the connector 14 so that user may plug in his/her own functional device 22, for example, MP3 player, i-pad, i-phone, CD player, or radio.

According to an exemplary embodiment of the present invention, the system 10 or 20 may also helps user stay connected by providing convenient, discreet storage for the user's favourite digital devices. The strategically located pocket is big enough to hold user's cell phone, portable music devices and the likes. The controller 16, i.e., control buttons/switches and the audio jack, may also be secured with a variety of anchoring means. In some embodiments, the anchoring means comprise means for securing the earphones to a structure proximate a person's ear such as a clip resiliently clamped on an ear auricle or a stud engaged into a hole pierced through said auricle.

The suitable position includes atleast a position in or on the upper clothing includes, lower clothing, inner clothing or any combination thereof. For example the position in the upper clothing includes atleast one of a stand collar, a hanging loop, a top collar, a shoulder line, a sleeve head, a lapel point (notch), a mock buttonhole, a armhole, a breast pocket, a buttonhole, a top fly (left front), a front dart, a underarm dart, a top sleeve, a sleeve button, a sleeve opening, a hem, a front cut, a front edge, a under sleeve, a flap, a change pocket, a front button, a under fly (right front), a inside breast pocket, a fold line, a lapel, a gorge line, a lining centre back pleat, a back lining , a top collar, a across back shoulders, a back armhole, a half back belt, a vent, a side seam, a centre back seam, a back yoke.

The position in the lower clothing includes atleast one of a waistband, a waistband button, a button tab, a waistband lining, a bearer button, an extended tab, a left fly, a fly buttonhole, a front fly, a crotch lining, a side seam, an inside seam, a reinforcement for knees, a leg opening, a turn-up cuff, a heel stay, a crease line, a fly button, a right fly, a slant side pocket, a waist pleat, a watch pocket, a belt loop, a hip pocket, a seat seam, a back pleat, a waistband, a side opening, an inverted pleat, a centre seam, a waist dart, a waist dart, a side opening, a front yoke, a pleats, a hem, a side seam, a slant welt pocket, a belt loop or any combination thereof.

Further position in the clothing also includes atleast one of a lining, a shoulder seam, an armhole, a breast welt pocket, a top fly, left front, a buttonhole, a side vent, a front point, an interlining, a right facing, a button, a waist welt pocket, a side seam, a breast dart, an under fly, right front, a shoulder seam, an armhole, a side seam, an adjustable waist tab, a back dart, a centre back seam or any combination thereof.

The functional device 22 may be mounted on a desired portion of the apparel 11. In this location, the weight and bulk of functional device 22 may be less likely to annoy the user or interfere with her activity. However, it is understood that functional device 22 may be located at numerous other locations on apparel 11, including but not limited to an upper sleeve area.

The system of claim 1 comprising atleast any one of the washable earphone or head phone with the microphone or mic only, the washable speaker only, an earpiece with the mike, two washable speakers and one earpiece with the mike, two earpieces with the mike and one speaker or any combination thereof.

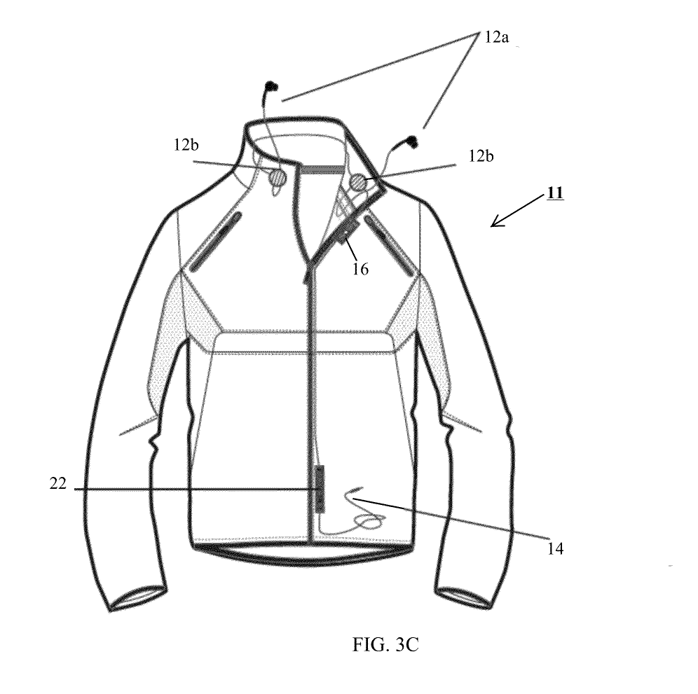

Referring to FIGS. 3A-3C illustrate exemplary systems of apparel 11 with inbuilt functional devices 22, according to an exemplary embodiments of the present invention. The system includes a garment, a pair of a washable speakers, a pair of washable earphone, washable audio jacks, controllers 16, functional device 22, etc.

According to an exemplary embodiment of the present invention, the speakers 12a and the headphones 12b with mike are connected to the control switches 16 thru a wire and washable circuit which may leads to 3.5 MM or any suitable size/dimension audio jack to connect with mobile phone, Portable audio players or other communication devices. The washable control button/switch may allows the user to control his/her device through the fabric, for example, to quickly accept or reject phone calls, select the appropriate music or sound effect, etc. With a few presses on the buttons, the wearer can easily play, pause, and rewind the songs he/she has on his player, as well as adjust the volume.

According to an exemplary embodiment of the present invention, the system of clothing may have any one of a head phone with the mike only, a speaker only, an earpiece with the mike, two speaker one earpiece with mike, two earpieces with mike and one speaker or any combination thereof.

According to an exemplary embodiment, the present invention provides garments with inbuilt washable speakers, washable earphone with mike and washable control switches for convenient use of mobile phones, portable audio players, and the like.

According to an exemplary embodiment, a system of garment according to the present invention may includes a piece of garment, atleast a washable speaker, a washable earphone with mic, washable control switches, connecting wire with washable audio jack.

According to an exemplary embodiment, the present invention is capable of providing convenience of using mobile phones and pocket audio players without holding in user's hands.

According to an exemplary embodiment, the present invention is capable of providing a garment which incorporates atleast a washable functional device which may be operated by a user wearing the garment.

According to an exemplary embodiment, the present invention is capable of providing a garment which may incorporates embedded speaker/earphones, mp-3, blue-tooth, solar charger, etc.

According to an exemplary embodiment, the present invention provides means to combine apparel with washable technologies, resulting in convenience and usability.

According to an exemplary embodiment of the present invention, the system of clothing may also helps user stay connected by providing convenient, discreet storage for the user's favorite digital devices. A strategically located pocket is big enough to hold user's cell phone, portable music devices and the likes.

In various exemplary embodiments of the present invention, the operations discussed herein, e.g., with reference to FIGS. 1 to 3C, may be implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. For example, the operation of components of the systems 10 and 20 may be controlled by such machine-readable medium.

In other instances, well-known methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

Although particular exemplary embodiments of the present invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A system of an apparel to operate atleast a functional device without holding in an user's hands, comprising:
atleast a communicator inbuilt with the apparel and communicably connected with the functional device;
atleast a controller inbuilt with the apparel to control operation of the functional device; and
atleast a connector inbuilt with the apparel to detachably connect atleast one of the functional device, the communicator, the controller or any combination thereof,
wherein atleast one of the communicator, connector, the controller, the functional device or any combination thereof is substantially water resistant and washable with the apparel,
wherein the functional device is capable of facilitating communication, health monitoring, learning, entertainment, and enjoyment.

2. The system of claim 1, wherein the functional device includes atleast one of a mobile phone, a portable media player, a MP-3 player, a MP-4 player, an i-pod, a-phone, a CD player, a DVD players, a tablet PC, a PDA, a media player ,a radio, a mobile phone, a RealAudio, a RTM player, a minidisk player, a cassette player, a satellite radio, a GPRS, a blue-tooth, a solar charger a Wi-Fi, a camera, a personnel assistant, a GSM phone adopter, an universal remote control, a VoIP Caller, a monitor, a storage, a digital book, brain trainer, habit builder, work out tracker, project management, temperature controller, language trainer, games playing, text book storage, audio recording, production efficiency work wear, or any combination thereof.

3. The system of claim 2 wherein the monitor includes atleast one of a health tracker capable of tracking, recording and prompting about atleast a health parameter, wherein the health parameters includes atleast one of pulse rate, blood pressure, body temperature, weight, memory, body mass index, Calorie, heart.

4. The system of claim 1, wherein the communicator includes atleast one of an inbuilt flexible washable speaker, an inbuilt washable earphone, atleast a washable microphone or any combination thereof.

5. The system of claim 1, wherein the controller includes atleast one of skip, forward, rewind, accept phone calls, reject phone calls, send multimedia messages, Bluetooth connectivity, Wi-Fi, media recording, play games, operate mobile applications, voice control, power-on, power-off, stop media, start media, pause media, call drop, redial, audio play, video play, voice dial, mute, select music, select sound effect, volume control, gesture control buttons, switches, and functionalities.

6. The system of claim 1, wherein the connector includes atleast one of a washable media jack, washable connecting wires, washable switches.

7. The system of claim 1, wherein the apparel may includes atleast one of an upper apparel, a lower apparel, an inner apparel or any combination thereof.

8. An apparel with atleast an inbuilt washable device for communication, entertainment, enjoyment, and health monitoring, comprising:
atleast a washable speaker inbuilt at a suitable position in the apparel;
atleast a washable earphone communicably connected with washable speaker;
atleast a washable controller inbuilt with the apparel for receiving input from the user to control and operate the washable device through the apparel; and
atleast a monitor connected with the apparel to communicably monitor atleast health of the user,
wherein atleast an inbuilt washable connector is adapted to connect atleast one of the washable device, the washable speaker, the washable headphone, the washable microphone, a washable earphone or any combination thereof with the washable operator for operation of the washable device by the user wearing the apparel.

9. The apparel of claim 8, wherein the controller includes atleast one of skip, forward, rewind, accept phone calls, reject phone calls, stop media, start media, pause media, send multimedia messages, Bluetooth connectivity, Wi-Fi, media recording, play games, operate mobile applications, voice control, power-on, power-off, call drop, redial, audio play, video play, voice dial, mute, select music, select sound effect, volume control, gesture control switch, button or functionalities or any combination thereof is adapted to control the electronic devices.

10. The apparel of claim 8 further comprising atleast a waterproof retainer with magnetic closures to retain atleast the washable device and preventing the washable device from falling out of user's pockets.

11. The apparel of claim 8, wherein the suitable position includes any position in or on atleast one of an upper apparel, a lower apparel, an inner apparel or any combination thereof.
